(19) United States
(12) Patent Application Publication
(10) Pub. No.: US 2008/0168374 A1
(43) Pub. Date: Jul. 10, 2008

(54) METHOD TO MANAGE EXTERNAL INDICATORS FOR DIFFERENT SAS PORT TYPES

(75) Inventors: Katherine T. Blinick, Tucson, AZ (US); Michael A. Curnalia, Tucson, AZ (US); Yutaka Kawai, Tokyo (JP); Gregg S. Lucas, Tucson, AS (US); Robert E. Medlin, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,652

(22) Filed: Jan. 6, 2007

(51) Int. Cl. G06F 3/048

(52) U.S. Cl. 715/771

(57) ABSTRACT

By use of a GUI (Graphical User Interface) or CLI (Command Line Interface) a user can issue a command to configure an external SAS Port as table routing mode or subtractive mode. The SAS switch receives and decodes the command. Subsequently, the SM asserts the appropriate indicator behavior for the port being addressed.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to use of a GUI (Graphical User Interface) or CLI (Command Line Interface) and particularly to a user issuing a command to configure an external SAS Port as table routing mode or subtractive mode. The SAS switch receives and decodes the command. Subsequently, the switch module (SM) asserts the appropriate indicator behavior for the port being addressed.

2. Description of Background

IBM's BLADECENTER product is integrating a SAS Storage Subsystem function including RAID CONTROLLER BLADES (RCBs) and DRIVE ENCLOSURE BLADES (DEBs). These components are installed within the BLADECENTER chassis and interconnected via the SAS switch module (SM). SM not only connects these components but also provides for external SAS Ports by means of external iPass connectors to connect to the external SAS initiators via iPass SAS cable as illustrated in FIGS. 1A and 1B.

SAS is short for Serial Attached SCSI, an evolution of parallel SCSI into a point-to-point serial peripheral interface in which controllers are linked directly to disk drives. SAS is a performance improvement over traditional SCSI because SAS enables multiple devices (up to 128) of different sizes and types to be connected simultaneously with thinner and longer cables; its full-duplex signal transmission supports 3.0 Gb/s. In addition, SAS drives can be hot-plugged.

In topologies with more than two connected devices, SAS calls for the use of expander devices to allow for more than one host to connect to more than one peripheral.

SAS devices can communicate with both SATA and SCSI devices (the backplanes of SAS devices are identical to SATA devices). A key difference between SCSI and SAS devices is the addition in SAS devices of two data ports, each of which resides in a different SAS domain. This enables complete failover redundancy if one path fails; there is still communication along a separate and independent path.

In SAS based Storage Systems a SAS (external) Port can assume different functional roles depending on how it is defined and used within the SAS topology.

To distinguish amongst the different types of SAS devices, the IEEE T10 Standards committee (SAS) has defined three types of iPass keying to support the three different external SAS Device types that can be attached to a SAS Switch: “End device”, “Enclosure OUT port” and “Enclosure IN port” as summarized in the table below and as illustrated in FIGS. 2A and 2B.

| Use | Key position |
|---|---|
| End device | 4 |
| Enclosure Out | 2 |
| Enclosure In | 6 |

Additionally, there has been defined a universal keying to whereby a single connector type can accommodate all three key positions. The universal iPass cable has all of the key position 2, 4 and 6 as illustrated in FIG. 3.

The Blade Center can provide any configuration for the SAS storage networking; therefore, the Switch Module (SM) needs to be connected to all cable types above. Even though any iPass cable can be connected to SM, SM needs to define the attribute mode at each SAS port to maintain its SAS topology. However, as mentioned above, the iPass cable key position will not be fixed so SM can not define the attribute mode on each SAS port in a factory ahead of time before iPass cables are connected.

It is standard art to implement a pair of indicators for each external SAS port on a SAS Switch. One indicator is green and indicates SAS Port Activity and the other indicator is amber and indicates a fault condition of sorts. It is also standard art to implement some type of icon associated with the SAS port to identify it as such. Indeed, the SAS Standards committee has defined symbols to denote the different types of device ports. However, it is impractical for a single symbol (icon) to have multiple meanings. In terms of user interface, it is advantageous for users that they can see physically or visually the attribute type of the each port. However, each SAS port of the SM must be flexible, depending on cable connections and connected SAS devices, which are occasionally changing. Therefore, the physical icons indicating specific SAS attribute type on the SM are useless (non-meaningful).

It should also be noted that cabling of different ports amongst myriad SAS switches could be confusing given the myriad configurations that are possible and the resultant different number of port types that can exist. Interconnecting inappropriate SAS ports amongst switches can be extremely troublesome and can result in significant down time in a customer's office. This applies to new installations but also applies to repair scenarios whereby a SAS Switch is replaced and a number of “dangling” cables must be re-installed in short order.

### SUMMARY OF THE INVENTION

The shortcomings of the prior art are overcome and additional advantages are provided through the provision of a method to manage external indicators for different SAS port types, the method comprising: allowing a user to issue a command to a SAS switch module, the SAS switch module having a plurality of physical interface ports, each of the plurality of physical interface ports having an attribute type, an indicator, and an operating mode, the operating mode being either a table route mode, or a subtractive mode; checking, by way of the SAS switch module, the attribute type of each of the plurality of physical interface ports; programming, by way of the SAS switch module, each of the indicators associated with each of the plurality of physical interface ports to flash at one hertz rate when the operating mode is the table routing mode and at two hertz or faster rate when the operating mode is the subtractive mode; and allowing the user to visually confirm the attribute type of each of the plurality of physical interface ports by inspection of each of the indicator associated with each of the plurality of physical interface ports.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which is a method of using the SAS Port Activity Indicator to indicate the port attribute type, by defining and associating unique indicator blink or flash rates for each of the unique port types possible.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1A-1B illustrates one example of an SAS switch module (SM);

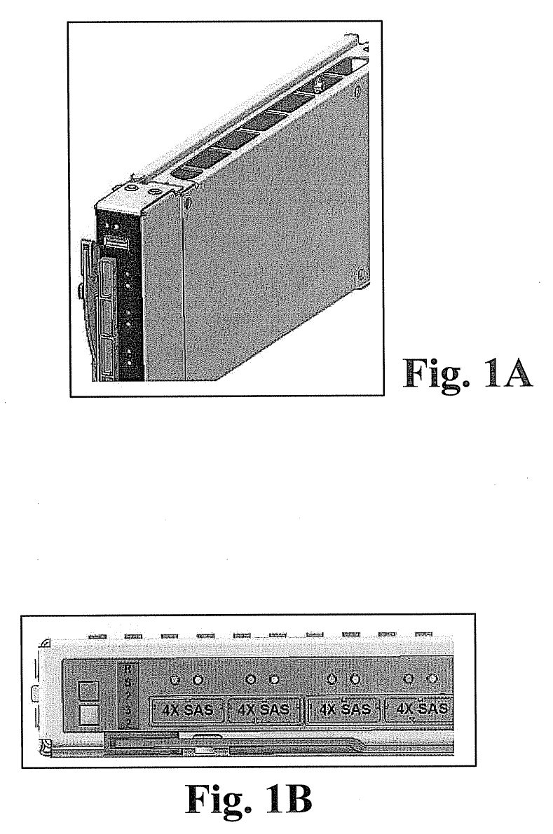

FIG. 2A-2B illustrates one example of an iPass SAS cable;

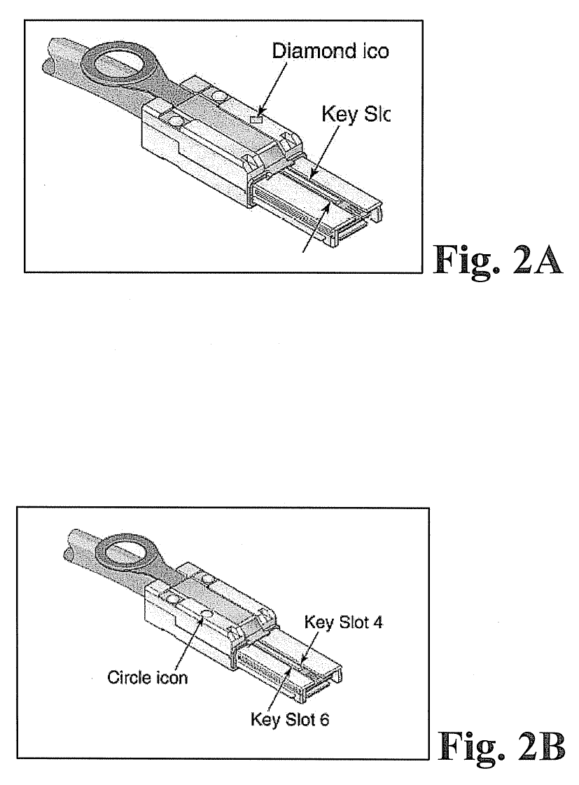

FIG. 3 illustrates one example of a universal iPass cable has all of the key position 2, 4 and 6; and

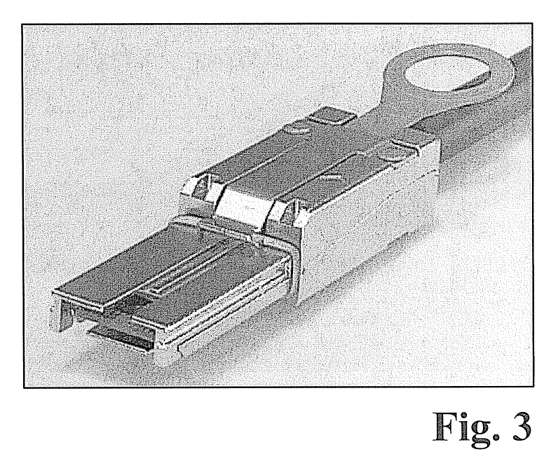

FIG. 4 illustrates one example of a method to manage external indicators for different SAS port types.

The detailed description explains the preferred embodiments of the invention, together with advantages and features, by way of example with reference to the drawings.

### DETAILED DESCRIPTION OF THE INVENTION

Turning now to the drawings in greater detail a unique blink pattern/flash rate for each of the SAS Device types is defined in the table below.

| Blink Pattern or Flash Rate | Attribute Mode |
|---|---|
| 1 Hz | Table routing mode |
| 2 Hz (or faster) | Subtractive mode |

In an exemplary embodiment, for example and not limitation two methods are described for applying the unique indicator settings.

In a first exemplary embodiment, by use of a GUI (Graphical User Interface) or CLI (Command Line Interface) a user can issue a command to configure an external SAS Port as table routing mode or subtractive mode. The SAS switch receives and decodes the command. Subsequently, the SM asserts the appropriate indicator behavior for the port being addressed.

In a second exemplary embodiment, autonomously and automatically, the SM “learns” its configuration via the standard SAS discovery process. It can detect all attached downstream ports and their attributes and determine what port types are attached to it. Another “automatic” scenario is when external cables are removed or connected. In such cases, the SM can detect cables being plugged/unplugged and when a cable is unplugged it can assert the respective indicator to identify the port type. Similarly, when a cable is plugged, the SM reprograms the indicator behavior to indicate its normal port activity status.

Further, it is important for each of the different indicator states to be unique from the other states so the customer/user can easily distinguish amongst the different states.

As a typical example, when the system is initially powered up and cables are not installed, the activity indicator would be in an ‘OFF’ state. Once the SM discovers its port types it programs the respective indicator to blink or flash at a given rate. The blink or flash rate for a table routed port must be sufficiently different (visually) from the blink or flash rate for a subtractive routed port. The next step would be to install cables, at which point the indicator will be asserted to a solid ‘ON’ state signifying a transition from un-cabled to a cabled and that one or more of the port physical interface (PHY) links has established a valid connection. Finally, when normal operation begins the indicator is programmed to reflect normal link activity. This last state will result in a very random blink/flash rate, a function of the random I/O activity on all the combined PHYs within that port. This random blink/flash rate will be substantially different from the fixed blink/flash rates.

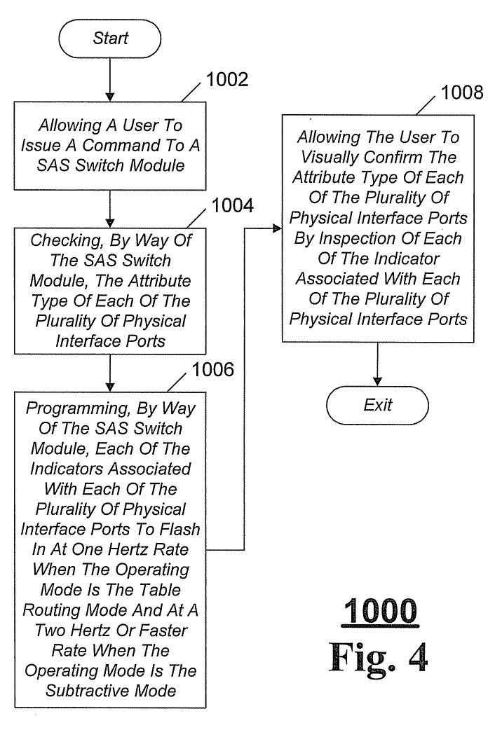

Referring to FIG. 4 there is illustrated one example of a method to manage external indicators for different SAS port types. In an exemplary embodiment, by use of a GUI (Graphical User Interface) or CLI (Command Line Interface) a user can issue a command to configure an external SAS Port as table routing mode or subtractive mode. The SAS switch receives and decodes the command. Subsequently, the SM asserts the appropriate indicator behavior for the port being addressed. In an exemplary embodiment, the following example method is one suggested procedure for how a manual process would manage the indicators. In this regard, the user issues a CLI command “port_type”, the SM checks each attribute type on each PHY, the SM programs the indicator to follow a predetermined specified pattern, and then the user can visually confirm the attribute mode of each SAS port. The method begins in block 1002.

In block 1002 a user is allowed to issue a command to a SAS switch module. Furthermore, the command is received by the SAS switch module and decoded. Processing then moves to block 1004.

In block 1004 a check is made by way of the SAS switch module of the attribute type of each of the plurality of physical interface (PHY) ports. Processing then moves to block 1006.

In block 1006 programming by way of the SAS switch module of each of the indicators associated with each of the plurality of physical interface ports occurs. In this regard, the indicators are programmed to flash at a one hertz rate when the associated port is operating in the table routine mode, and at a two hertz or faster rate when operating in the subtractive mode. Processing then moves to block 1008.

In block 1008 the user is allowed to confirm the attribute type of each of the plurality of physical interface (PHY) ports by inspection of each of the indicators associated with each of the PHY ports. The routine is then exited.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method to manage external indicators for different SAS port types, said method comprising:
allowing a user to issue a command to a SAS switch module, said SAS switch module having a plurality of physical interface ports, each of said plurality of physical interface ports having an attribute type, an indicator, and an operating mode, said operating mode being either a table route mode, or a subtractive mode;
checking, by way of said SAS switch module, said attribute type of each of said plurality of physical interface ports;
programming, by way of said SAS switch module, each of said indicators associated with each of said plurality of physical interface ports to flash at one hertz rate when said operating mode is said table routing mode and at two hertz or faster rate when said operating mode is said subtractive mode; and
allowing said user to visually confirm said attribute type of each of said plurality of physical interface ports by inspection of each of said indicator associated with each of said plurality of physical interface ports.

2. The method in accordance with claim 1, further comprising:
receiving at said SAS switch module said command.

3. The method in accordance with claim 2, further comprising:
decoding, by way of said SAS switch module, said command.

4. The method in accordance with claim 3, wherein a plurality of universal iPass cables are plugged into said SAS switch module.

5. The method in accordance with claim 4, wherein said command is a command line interface (CLI) command.

6. The method in accordance with claim 4, wherein said command is communicated by way of a graphical user interface (GUI).

7. The method in accordance with claim 5, wherein each of said indicators associated with each of said plurality of physical interface ports when solid ‘ON’ signifies transitions from un-cabled to cabled status and that a valid data connection has been established.

8. The method in accordance with claim 7, wherein each of said indicators associated with each of said plurality of physical interface ports flashes randomly to indicate normal operation and signify data communication activity.
